(19) United States
(12) Patent Application Publication
(10) Pub. No.: US 2002/0087430 A1
(43) Pub. Date: Jul. 4, 2002

(54) Universal shopping basket

(76) Inventors: Tony Davis, Thornhill (CA); Colin Sampaleanu, Toronto (CA); Damjan Majstorovic, Thornhill (CA); Kant Hung, Scarborough (CA); Nicolae Vintila, North York (CA); Peter Cheung, Richmond Hill (CA)

Correspondence Address: Breiner & Breiner, L.L.C., P.O. Box 19290, Alexandria, VA, 22320-0290, US

(21) Appl. No.: 09/911,482

(22) Filed: Jul. 25, 2001

Related U.S. Application Data
(60) Provisional application No. 60/221,126, filed on Jul. 27, 2000.

(51) Int. Cl. G06F 17/60

(52) U.S. Cl. 705/26; 705/28

(57) ABSTRACT

A universal shopping basket for purchasing products form electronic commerce websites of multiple merchants using a single check-out processed is disclosed. The universal shopping basket can be used with any electronic commerce website without requiring extra effort for the merchant.

### CROSS REFERENCE TO RELATED APPLICATIONS

The present invention claims priority from U.S. provisional patent application serial No. 60/221,126 file on Jul. 27, 2000. United States patent application entitled “Method and System for International Shopping” claiming priority from U.S. provisional patent application serial Nos. 60/221,125 and 60/221,141 has been filed concurrently herewith.

### FIELD OF THE INVENTION

The present invention relates to the field of electronic commerce. More specifically, the present invention relates to universal shopping baskets used for electronic commerce.

### BACKGROUND OF THE INVENTION

Purchasing products through electronic methods (i.e. electronic commerce) is becoming increasingly more common as consumers realize the convenience of shopping at multiple electronic stores 24 hours a day from a single physical location. Every merchant that offers electronic commerce has a system through which electronic commerce is offered. These systems have shopping baskets containing references to all products being purchased by a customer from that merchant. However, when purchasing products from multiple merchants the purchase transaction is very repetitious as each merchant generally uses the same information for a purchase transaction (i.e. name, credit card number, shipping address, etc.).

While there are third party services that try to resolve this problem, the solutions currently offered are restricted to a small number of merchants. For example, della.com (http://www.della.com) offers a single shopping cart, and thus a single checkout process, for multiple merchants; however, a merchant generally establishes a relationship with the third party service before customers can purchase goods through the third party service. As a result a customer is limited in the number of merchants from which goods can be purchased through the third party service, resulting in limited use of such service.

While setting up a relationship with a third party service offering a universal shopping cart can be beneficial to a merchant, it can also involve significant effort. The merchant integrates their existing electronic commerce system with the third party service. This is achieved by providing the third party service with full access to the merchant's product database, or constant updates of the database. The merchant's database will have to conform to the protocols specified by the third party service, either directly or through mapping that is coded by the merchant.

### SUMMARY OF THE INVENTION

Accordingly, it is an object of the present invention to provide a system that can be used to purchase products from any merchant having an electronic commerce system.

It is an object of the present invention to provide a universal shopping basket separate from a merchant for the merchant's products to be purchased.

In accordance with one aspect of the present invention there is provided a system for purchasing products from a plurality of unrelated merchants offering products for purchase through electronic commerce systems, said system comprising: an information gatherer for obtaining information from a target merchant relating to available products for purchase, said target merchant being at least one of the plurality of unrelated merchants; and a purchase requester for providing the target merchant with a purchase request made on behalf of the purchaser.

In accordance with another aspect of the present invention there is provided a method for purchasing products from a plurality of unrelated merchants offering products for purchase through electronic commerce systems, said method comprising: obtaining information from a target merchant relating to available products for purchase, said target merchant being at least one of the plurality of unrelated merchants; and providing the target merchant with a purchase request made on behalf of the purchaser.

In accordance with a further aspect of the present invention there is provided a computer readable medium having stored thereon computer-executable instructions for purchasing products from a plurality of unrelated merchants offering products for purchase through electronic commerce systems, the computer-executable instructions performing the steps comprising: obtaining information from a target merchant relating to available products for purchase, said target merchant being at least one of the plurality of unrelated merchants; and providing the target merchant with a purchase request made on behalf of the purchaser.

### BRIEF DESCRIPTION OF THE DRAWINGS

FIG. 1 is a system diagram of an electronic commerce system using a universal shopping basket according to an embodiment of the present invention;

FIG. 2 is a system diagram of a universal shopping basket according to an embodiment of the present invention;

FIG. 3 is a flow diagram illustrating a product being added to the universal shopping basket;

FIG. 4 is a flow diagram illustrating a customer transaction request for products in the universal shopping basket;

FIG. 5 is a system diagram of a purchase processor; and

FIG. 6 is a flow diagram illustrating a purchase transaction in a purchase processor.

### DETAILED DESCRIPTION

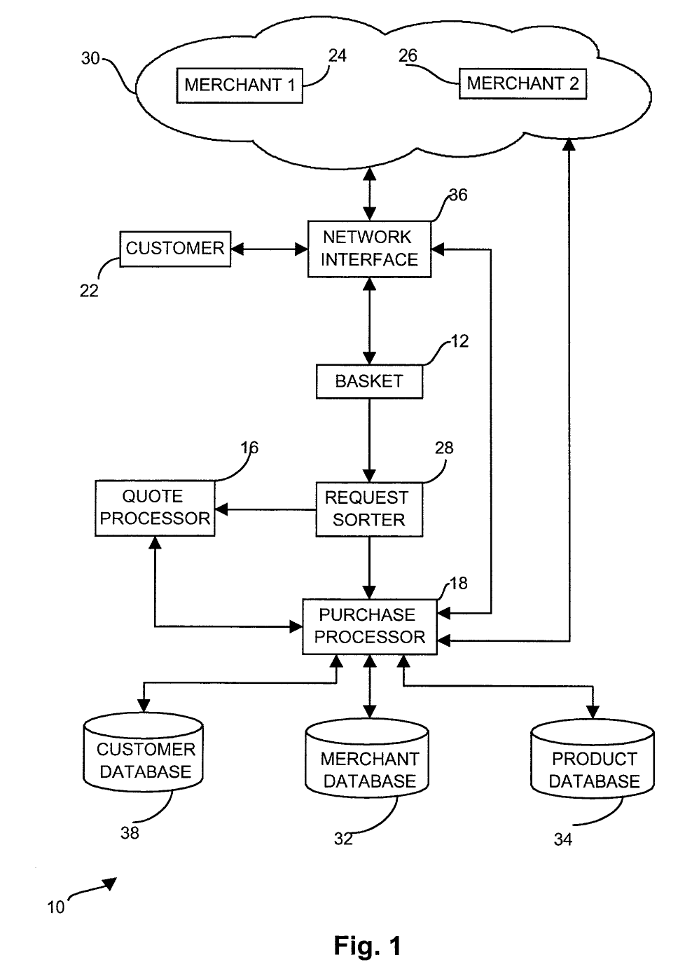

FIG. 1 shows an electronic commerce system 10 according to an embodiment of the present invention. Individual merchants 24, 26 have separate electronic commerce systems connected over a network 30, such as the Internet, through which a customer 22, via a network interface 36 (e.g. a web browser, such as Netscape Navigator® or Microsoft Internet Explorer®), can purchase products offered by each merchant 24, 26. The products sold via the merchants 18, 22 may be any product, service or manufactured good. In a traditional electronic commerce system, if a customer 22 wanted to purchase one product from one merchant 24 and a second product from a second merchant 26 then two separate purchase transactions, one with each merchant 24, 26, had to be performed.

The present invention allows the customer 22 to transact with multiple merchants 24, 26 through a single universal shopping basket 12 resulting in a single purchase transaction according to the customer's view. The universal shopping basket 12 is separate from, but acts in a manner similar to, shopping baskets provided by each individual merchant 24, 26 (i.e. shopping baskets known in the art). The customer 22 interacts directly with the merchant's electronic commerce system to examine products but for all transactions the customer 22 goes through the universal shopping basket 12. These transactions may include, but are not limited to purchases and foreign currency price quotes.

The universal shopping basket 12 is connected to a request sorter 28 that receives transaction requests from the universal shopping basket 12. A request sorter 28 may be part of any third party processing system to which the basket 12 interfaces, such as a quote processor 16 and a purchase processor 18. For transaction types other than purchases, additional processors such as the quote processor 16 may interface with the universal shopping basket 12. Each of the quote processor 16 and the purchase processor 18 may have their own request sorter (not shown) or, alternatively, a universal request sorter 28 may be used for multiple processors 16 and 18. A universal request sorter 28 could be part of a service offered by a third party, for example, Delano®'s Customer Velocity®. An exemplary quote processor 16 is described in commonly assigned co-pending applications titled “Method and System for International Shopping” (U.S. provisional patent application serial Nos. 60/221,125 and 60/221,141), hereby incorporated by reference.

The quote processor 16 may be part of a service offered by a third party to allow the customer 22 the ability to receive a price quote for a product from a foreign merchant in local currency including shipping, handling, tariffs, duties and taxes. Currently, when products are purchased from a merchant using a different currency in a foreign country the customer 22 does not know the total cost for a product until a credit card bill is received and all extra taxes and duty fees have been paid. The quote processor 16 allows the user to receive a fixed price for a desired product, thus eliminating product price uncertainties associated with currency exchange rates, duties, tariffs, and shipping.

The purchase processor 18 in conjunction with the universal shopping basket 12 offers the customer 22 the ability to purchase multiple products from multiple merchants 24, 26 with a single purchase transaction from the customer's view. The merchants 24, 26 do not need to be registered partners of the universal shopping basket 12 provider but may be any merchant having an electronic commerce system. The purchase processor 18 receives information from the universal shopping basket 12 about products in the basket 12 and the merchant 24, 26 of these products. The purchase processor 18 then purchases each product from their respective merchant 24, 26.

The purchase processor 18 interfaces with a number of databases containing information that is used to enhance a purchase transaction. A customer database 38 may contain information on each customer 22 using the universal shopping basket 12. This customer information includes information such as, for example, a customer name, preferred shipping addresses, preferred credit card information and a customer identifier. A merchant database 32 contains policy information, such as return policy, satisfaction guarantee, etc., for merchants from whom products are purchased using the universal shopping cart 12. A product database 34 contains information on the products frequently purchased through the universal shopping basket 12. These databases 30, 32, 34 assist the purchase processor 18 in providing a universal electronic purchasing system.

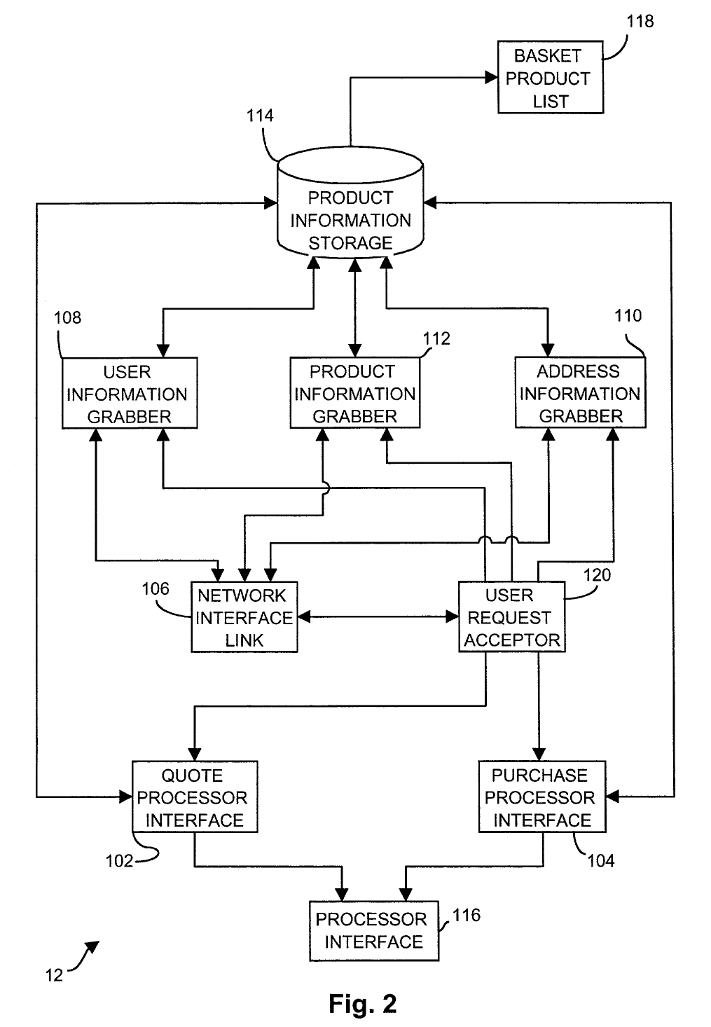

FIG. 2 is a system diagram depicting the universal shopping basket 12. The universal shopping basket 12 is linked to the network 30 connecting the merchants 24, 26 by the network interface 36 via a network interface link 106. The network interface 36 is used by the customer 22 for viewing products on the electronic commerce system of each merchant 24, 26. The network interface link 106 allows the universal shopping basket 12 to obtain information about a product desired by the customer 22 from the merchant's 24, 26 electronic commerce system by way of the network interface 36.

When a customer 22 submits a transaction request to the universal shopping basket 12, a user request acceptor 120 receives the request from the network interface link 106 and coordinates fulfillment of the request in the universal shopping basket 12. When a product is to be added to the universal shopping basket 12, the user request acceptor 120 has an address information grabber 110 that takes the address of the current product information being viewed by the customer 12 when the request is made from the merchant's 24, 26 electronic commerce system. A product information grabber 112 copies the product information of the current product being viewed by the customer 22.

In the case where the network 30 to which the universal shopping basket 12 interfaces is the Internet, the address is a URL (uniform resource locator), the product information is in HTML (hypertext markup language) format, and the network interface link 106 can be, for example, a bookmarklet. The network interface link 106 provides the universal shopping basket 12 with access to many properties of the product information being viewed by the customer 22 on the network interface 36 such as the address of the product information and the coding of the product information (e.g. HTML representation of price, size, colour, etc.). When the request to add a product to the basket 12 was made, the customer 22 may have submitted an additional product description that is taken by a user information grabber 108.

The address of the product information for each product, a copy of the product information captured when the customer submits the product to the universal shopping basket 12 as well as descriptive information provided by the customer 22 are all stored in the product information storage 114 until a transaction request is submitted. A basket product list 118 contains a listing of all products in the universal shopping basket 12.

When a transaction request is received, the user request acceptor 120 causes information about the contents of the universal shopping basket 12 to be forwarded to the quote processor interface 102 or the purchase processor interface 104, based on the type of transaction request received by the user request acceptor 120. The quote processor interface 102 packages information about the products in the basket 12 and customer 22 identification information to be forwarded to the quote processor 16. The purchase processor interface 104 packages the product information to be forwarded to the purchase processor 18. If the universal shopping basket 12 interfaces with additional processors then appropriate interfaces may be added. The quote processor interface 102 and the purchase processor interface 104 forward all packages to the processor interface 116 to be sent to the appropriate processor 16, 18.

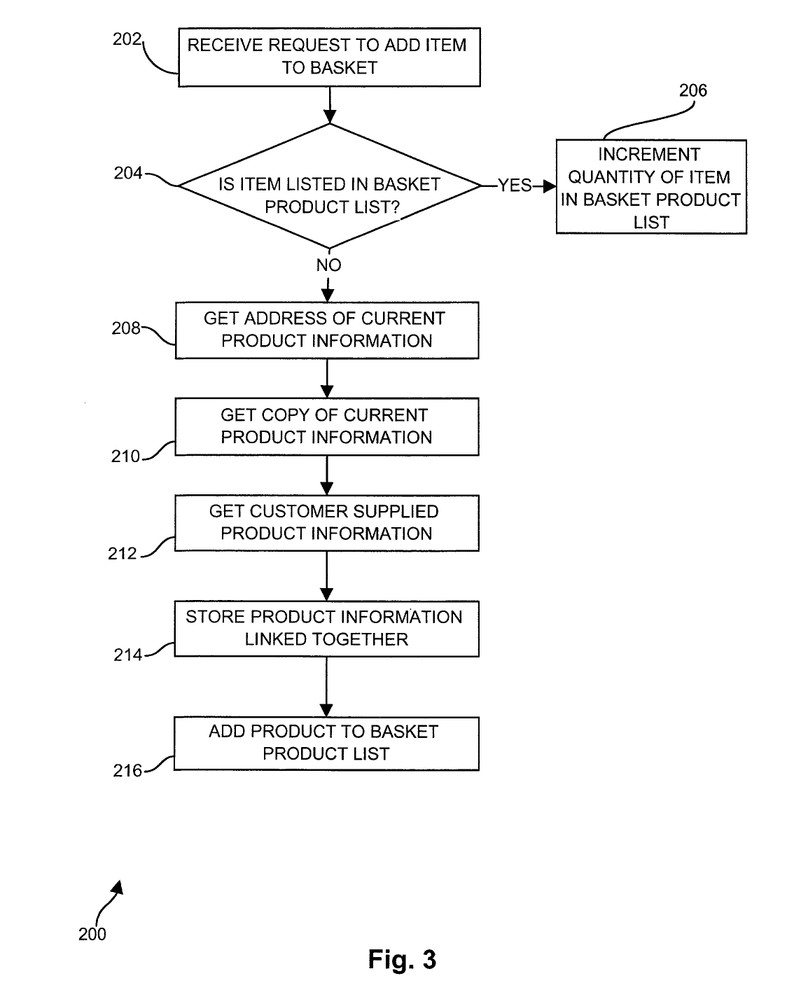

FIG. 3 shows a flow diagram illustrating a process 200 of a product being added to the universal shopping basket 12. The universal shopping basket 12 receives a request in step 202 from a customer 22 to add a product to the universal shopping basket 12. The universal shopping basket 12 determines if the current product is already among any products in the basket product list in step 204. If the current product is in the basket 12 then the quantity of that product in the basket 12 is increased in step 206. If the product is not listed as being in the basket 12 then the address from the merchant's 24, 26 electronic commerce system of the product being viewed by the customer 22 on the network interface 36 is taken in step 208. The universal shopping basket 12 copies the product information being viewed in step 210. Product information supplied by the customer 22 is also taken by the universal shopping basket in step 212. The product information address, the copy of the product information and the customer supplied product information are all stored linked together in the universal shopping basket in step 214. The current product is then added to the basket product list in step 216 of products already in the universal shopping basket 12.

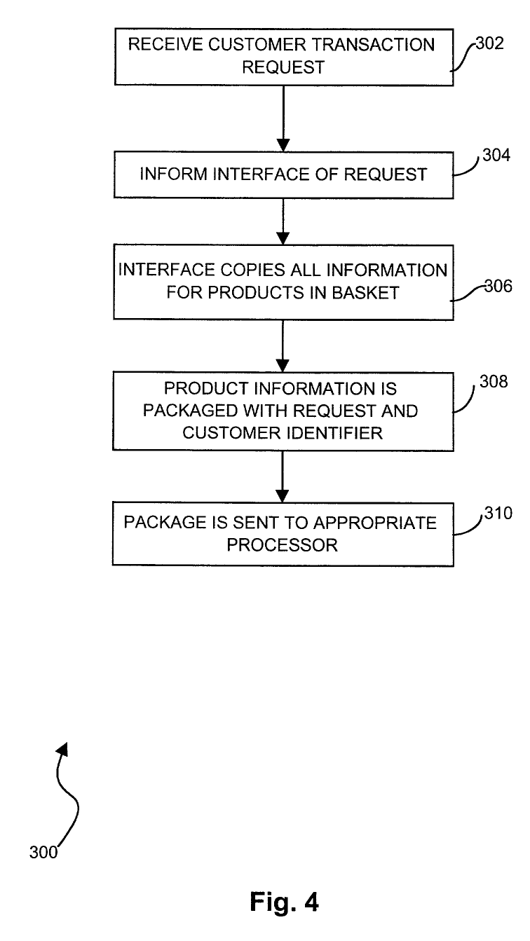

FIG. 4 illustrates the process 300 of a customer transaction request being processed by the universal shopping basket 12. A customer transaction request is received by the universal shopping basket in step 302. Based on the type of transaction requested an appropriate specific interface is informed of the request in step 304. The universal shopping basket 12 copies product information about the products in the basket in step 306. Product information for all products in the universal shopping basket 12, the type of request and a customer identifier are packaged in step 308 and sent to the appropriate processor via the processor interface in step 310.

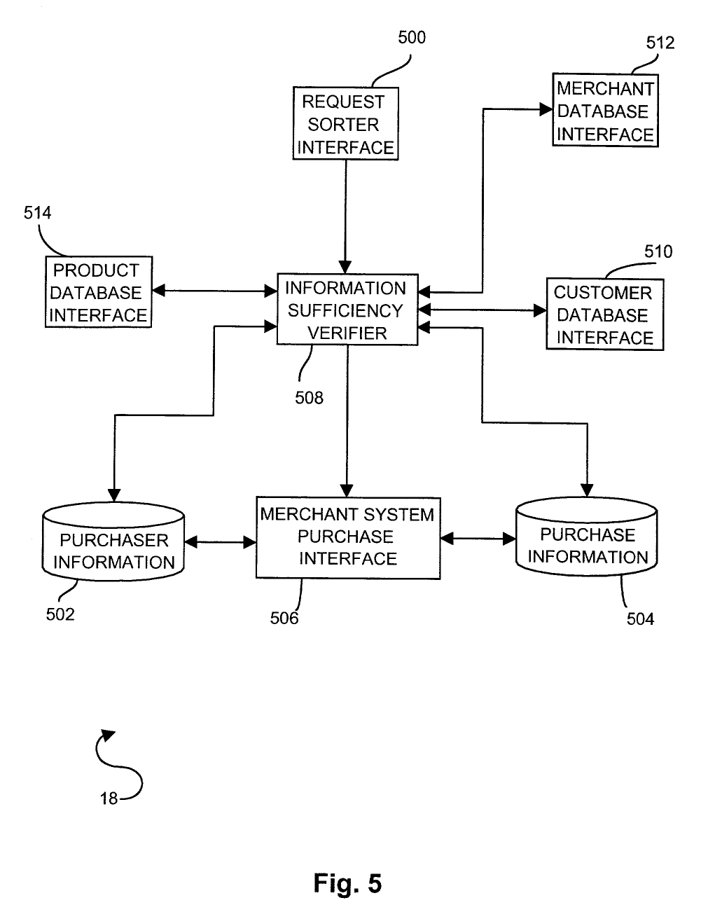

FIG. 5 shows a system diagram depicting the purchase processor 18. A request sorter interface 500 receives a purchase request including a package of information containing customer identification and information on the products to be purchased. This information is separated by an information sufficiency verifier 508 into purchase information 504 and purchaser information 502. The information sufficiency verifier 508 compares the purchase information 504 with information in the product database 34, accessed via the product database interface 514. If additional information is available in the product database 34 but not supplied in the package of information, then notice is sent to the customer 22 that not enough information was provided to complete the transaction. The information sufficiency verifier 508 uses the customer database 38, accessed via the customer database interface 510, to supplement the purchaser information 502 for the purchase transaction. Information on the merchants in the merchant database 32 from whom products will be purchased are examined by the information sufficiency verifier 508, via a merchant database interface 512, to determine if there is a special purchase process or other uncommon processes. If the purchase information 504 and purchaser information 502 are sufficient then a merchant system purchase interface 506 places a purchase order directly with the electronic commerce system of each merchant.

The merchant system purchase interface 506 can place an order through the merchant's 24, 26 electronic commerce system in a variety of ways. The merchant system purchase interface 506 can simulate the actions the customer 22 would take to purchase a product directly from the merchant 24, 26. This might include actions such as automatically filling out forms and navigating through subsequent information requests and displays. Alternatively, the merchant system purchase interface 506 could purchase a product by interfacing directly with the merchant 24, 26 providing a file containing purchase information such as products to be purchased, shipping information and payment information. This file includes such information as line number, item description, quantity, price, relevant shipping information (e.g. address, etc.) and payment information (e.g. credit card number and expiry date). The file for purchasing products may be in a flat file or tree file structure and may be submitted to the merchant 24, 26 either as part of a batch process or in real-time. The merchant system purchase interface 506 also interfaces with the network interface 36 to provide the customer 22 with information on the status of the purchase transaction.

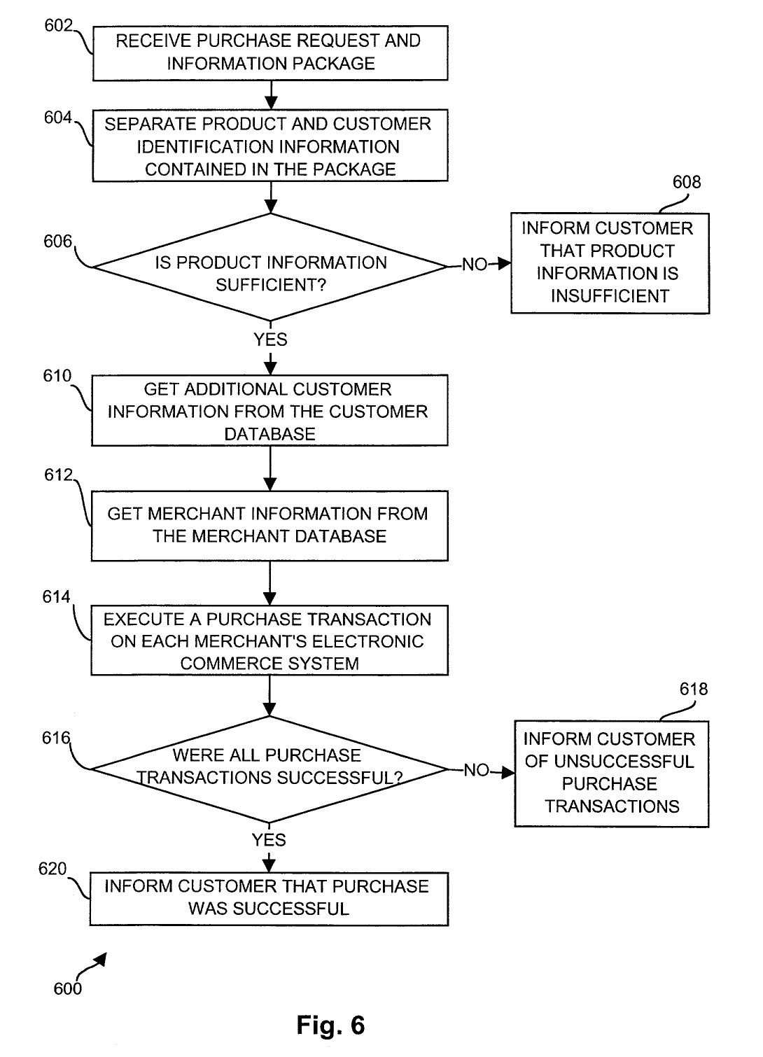

FIG. 6 illustrates a purchase transaction process 600 according to the purchase processor 18. A purchase request and information package are received from the universal shopping basket 12 in step 602. In step 604 the product and customer identification information contained in the package are separated. The product information supplied is examined in step 606 to determine if the information is sufficient to execute a purchase transaction. If the product information supplied is insufficient then the customer is informed in step 608 that additional information needs to be supplied to complete the transaction. If the product information is sufficient then additional customer information is obtained in step 610 from the customer database 38. Merchant information is obtained from the merchant database 32 in step 612. A purchase transaction is executed on each merchant's electronic commerce system from whom products are to be purchased in step 614. In step 616 it is determined if the purchase transactions were successful. If not all purchase transactions were successful the customer is informed of this in step 618. If the purchase transactions were successful then the customer receives notification in step 620 that the purchases were completed.

In an exemplary embodiment the present invention can be implemented in Javascript. Once the product information and address (e.g. HTML and URL information) are captured, the Javascript creates a first basket page. The first page contains hidden input fields that are used to pass the information in the basket (e.g. HTML and URL) to a server-side object (e.g. a JavaBean) where it will write the item information to the product database and forward the user to the next page that displays the item list. In the exemplary embodiment, the actions of HTTP:Get and HTTP:Post are used for obtaining product information and supplying it to the product database. The information obtained is the product data (HTML code), page tittle, and the URL of the product data. In the exemplary embodiment, for merchant's having product data displayed using frames, the product data is obtained by identifying all frames and sorting them by size and title to identify the most likely frame to contain product information.

In summary, the present invention provides a universal shopping basket for purchasing products from electronic commerce websites of multiple merchants using a single check-out processed. The universal shopping basket can be used with any electronic commerce website without requiring extra effort for the merchant.

It is apparent to one skilled in the art that numerous modifications and departures from the specific embodiments described herein may be made without departing from the spirit and scope of the invention.

1. A system for purchasing products from a plurality of unrelated merchants offering products for purchase through electronic commerce systems, said system comprising:
an information gatherer for obtaining information from a target merchant relating to available products for purchase, said target merchant being at least one of the plurality of unrelated merchants; and
a purchase requester for providing the target merchant with a purchase request made on behalf of the purchaser.

2. The system according to claim 1 wherein the information gatherer includes:
a merchant information gatherer for obtaining product information from the target merchant about a product to be purchased by the purchaser;
a purchaser information gatherer for obtaining information about the purchaser making the purchase of the product.

3. The system according to claim 2 wherein the merchant information gatherer includes:
a product location gatherer for obtaining a location on an electronic commerce system of the target merchant of product information for the product to be purchased through the electronic commerce system.

4. The system according to claim 1 wherein the purchase requester includes:
an information checker for checking product and purchaser information to determine if sufficient information has been provided for a purchase transaction; and
a transaction creator for interfacing with the target merchant to purchase the product.

5. A method for purchasing products from a plurality of unrelated merchants offering products for purchase through electronic commerce systems, said method comprising:
obtaining information from a target merchant relating to available products for purchase, said target merchant being at least one of the plurality of unrelated merchants; and
providing the target merchant with a purchase request made on behalf of the purchaser.

6. The method according to claim 5 wherein the step of obtaining information from the target merchant includes:
gathering product information from the target merchant for a product to be purchased by the purchaser; and
obtaining information about the purchaser.

7. The method according to claim 6 wherein the step of gathering product information includes;
gathering a location on an electronic commerce system of the target merchant of product information for the product to be purchased on the electronic commerce system.

8. The method according to claim 5 wherein the step of providing the target merchant with a purchase request includes:
checking product and purchaser information to determine if sufficient information has been provided for a purchase transaction; and
interfacing with the target merchant to purchase the product.

9. A computer readable medium having stored thereon computer-executable instructions for purchasing products from a plurality of unrelated merchants offering products for purchase through electronic commerce systems, the computer-executable instructions performing the steps comprising:
obtaining information from a target merchant relating to available products for purchase, said target merchant being at least one of the plurality of unrelated merchants; and
providing the target merchant with a purchase request made on behalf of the purchaser.

10. The computer-readable medium according to claim 9 wherein the step of obtaining information from the target merchant includes:
gathering product information from the target merchant for a product to be purchased by the purchaser; and
obtaining information about the purchaser.

11. The computer-readable medium according to claim 10 wherein the step of gathering product information includes;
gathering a location on an electronic commerce system of the target merchant of product information for the product to be purchased on the electronic commerce system.

12. The computer-readable medium according to claim 9 wherein the step of providing the target merchant with a purchase request includes:
checking product and purchaser information to determine if sufficient information has been provided for a purchase transaction; and
interfacing with the target merchant to purchase the product.
